(19) United States
(12) Patent Application Publication
(10) Pub. No.: US 2025/0239000 A1
(43) Pub. Date: Jul. 24, 2025

(54) Graphics Processing

(71) Applicant: Arm Limited, Cambridge (GB)

(72) Inventor: Marius Bjørge, Trondheim (NO)

(73) Assignee: Arm Limited, Cambridge (GB)

(21) Appl. No.: 19/029,441

(22) Filed: Jan. 17, 2025

(30) Foreign Application Priority Data
Jan. 24, 2024 (GB) 2400915.1

(51) Int. Cl. G06T 15/06; G06T 17/00

(52) U.S. Cl. CPC G06T 15/06; G06T 17/005; G06T 2210/61

(57) ABSTRACT

A graphics processing system that is operable to perform ray tracing is disclosed. An ordering strategy for determining an order in which to test rays against child nodes of a parent node is selected, and ordering information indicative of the selected ordering strategy is stored in association with the parent node. Then, when tracing a ray the stored ordering information can be used to determine an order in which to test a ray against child nodes of the parent node.

### BACKGROUND

The technology described herein relates to graphics processing systems, and in particular to the rendering of frames (images) for display using ray tracing.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called “ray tracing”. Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value for a sampling position in the image (plane) is determined based on the object(s) in the scene intersected by the ray passing through the sampling position, and the properties of the surfaces of those objects. The ray tracing calculation is complex, and involves determining, for each sampling position, a set of (zero or more) objects within the scene which a ray passing through the sampling position intersects.

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object in the scene is identified. This first intersection will be with the object in the scene closest to the sampling position. In this example, the first intersected object is represented by a set (e.g. mesh) of triangle primitives, and the ray 20 is found to intersect a triangle primitive 25 representing the object. A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Primary, reflection and refraction rays may be referred to as “closest-hit rays”, since they are typically traced until intersecting geometry closest to the ray's origin is found (or until it is determined that the ray does not intersect any geometry). On the other hand, shadow rays may be referred to as “first-hit rays” or “visibility rays”, as they can typically be terminated as soon as they are found to intersect any geometry (or when it is determined that the ray does not intersect any geometry).

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation, and so it is usually desirable to be able to accelerate ray tracing.

The Applicant believes that there remains scope for improved techniques for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3A and FIG. 3B show exemplary ray tracing acceleration data structures;

FIG. 4A and FIG. 4B are flow charts illustrating embodiments of a full ray tracing process;

FIG. 5 is a schematic diagram illustrating a “hybrid” ray tracing process;

FIG. 6 shows schematically an embodiment of a graphics processor that can be operated in the manner of the technology described herein;

FIG. 7 shows schematically in more detail elements of a graphics processor that can be operated in the manner of the technology described herein;

FIG. 8A and FIG. 8B show schematically a stack layout that may be used for managing a ray tracing traversal operation in embodiments of the technology described herein;

FIG. 9 is a flow chart illustrating embodiments of a ray tracing traversal operation;

FIG. 10 illustrates a number of child node ordering strategies in accordance with embodiments; and

FIG. 11 illustrates a ray tracing acceleration data structure generation process in accordance with embodiments.

### DETAILED DESCRIPTION

A first embodiment of the technology described herein comprises a method of operating a graphics processing system that is operable to perform ray tracing using a ray tracing acceleration data structure that comprises a plurality of nodes, wherein each node of the plurality of nodes represents a respective volume, and the plurality of nodes includes at least one parent node that is associated with a respective set of child nodes;
wherein the graphics processing system is operable to trace a ray by traversing the ray tracing acceleration data structure and testing the ray against nodes of the ray tracing acceleration data structure to determine whether the ray intersects volumes represented by the nodes, and when it is determined that the ray intersects a volume represented by a parent node, testing the ray against child nodes of the parent node;
the method comprising, for at least one parent node of the ray tracing acceleration data structure:
   selecting an ordering strategy for determining an order in which to test rays against child nodes of the parent node; and
   storing, in association with the parent node, ordering information indicative of the selected ordering strategy;
the method further comprising, when tracing a ray:
traversing the ray tracing acceleration data structure, and when it is determined that the ray intersects a volume represented by a parent node for which ordering information is stored:
   determining, using the stored ordering information, an order in which to test the ray against child nodes of the parent node; and
   causing the ray to be tested against child nodes of the parent node in accordance with the determined order.

A second embodiment of the technology described herein comprises a graphics processing system that is operable to perform ray tracing using a ray tracing acceleration data structure that comprises a plurality of nodes, wherein each node of the plurality of nodes represents a respective volume, and the plurality of nodes includes at least one parent node that is associated with a respective set of child nodes;
the graphics processing system comprising:
a ray tracing circuit operable to trace a ray by traversing a ray tracing acceleration data structure and testing the ray against nodes of the ray tracing acceleration data structure to determine whether the ray intersects volumes represented by the nodes, and when it is determined that the ray intersects a volume represented by a parent node, testing the ray against child nodes of the parent node; and
a processing circuit operable to, for at least one parent node of a ray tracing acceleration data structure:
   select an ordering strategy for determining an order in which to test rays against child nodes of the parent node; and
   store, in association with the parent node, ordering information indicative of the selected ordering strategy;
wherein the ray tracing circuit is operable to, when tracing a ray:
traverse a ray tracing acceleration data structure, and when it is determined that the ray intersects a volume represented by a parent node for which ordering information has been stored by the processing circuit:
   determine, using the stored ordering information, an order in which to test the ray against child nodes of the parent node; and
   cause the ray to be tested against child nodes of the parent node in accordance with the determined order.

The technology described herein is concerned with a graphics processing system performing ray tracing. In the technology described herein, the graphics processing system (comprises a ray tracing circuit that) is operable to perform ray tracing by traversing a ray tracing acceleration data structure. The ray tracing acceleration data structure comprises a plurality of nodes, with each node of the plurality representing a respective volume, and at least one of the nodes being a parent node associated with a respective set of child nodes. In embodiments, the respective volumes represented by a respective set of child nodes are (all) encompassed by the volume represented by the corresponding parent node.

The ray tracing acceleration data structure may be arranged as a hierarchy of nodes representing a hierarchy of volumes, e.g. and in embodiments, the ray tracing acceleration data structure comprises one or more bounding volume hierarchies (BVHs). Thus, in embodiments, a (each) node of the ray tracing acceleration data structure can be a parent node (internal node) that has a set of child nodes, or an end (e.g. leaf) node that does not have a set of child nodes. In embodiments, a (each) end (e.g. leaf) node is associated with (represents) a set of geometry that falls within the (respective) volume that the end (e.g. leaf) respective node represents.

The graphics processing system (e.g. comprises a ray-volume intersection testing circuit that) is operable to test rays for intersection with volumes that are represented by the nodes of the ray tracing acceleration data structure (e.g. BVH). In embodiments, when a ray is found to intersect a parent node volume that is associated with a set of child nodes, the ray is tested for intersection with the volumes that the child nodes represent (e.g. by the ray-volume intersection testing circuit).

In embodiments, when a ray is found to intersect a node that is associated with geometry, e.g. when a ray is found to intersect an end (e.g. leaf) node having associated geometry, the ray is tested for intersection with the geometry that the (e.g. end/leaf) node corresponds to (e.g. by a ray-geometry intersection testing circuit of the graphics processing system). The use of a ray tracing acceleration data structure in this manner can speed up the determination of which (if any) geometry is intersected by a ray, and thus can significantly accelerate ray tracing.

The Applicant has recognised that an order in which to test child nodes of a parent node can be chosen. Accordingly, one way to (further) accelerate ray tracing is to select a child node processing order, e.g. so as to try to shorten the overall time taken to find intersecting geometry (if any). The Applicant has recognised, however, that it can be the case that the optimum strategy for determining an order in which to test child nodes can vary, e.g. depending on factors such as the type of ray being traced, the nature and content of the scene or object being rendered, and the structure of the ray tracing acceleration data structure.

For example, and as will be discussed in more detail below, it may sometimes be advantageous to select a “front-to-back” ordering strategy in which child nodes that represent volumes that are closer to the ray's origin are tested before child nodes that represent volumes that are further away from the ray's origin. In other circumstances, it may be advantageous to select a “back-to-front” ordering strategy, or a “largest-to-smallest” ordering strategy in which child nodes that represent larger volumes are tested before child nodes that represent smaller volumes, or another ordering strategy.

In the technology described herein, a strategy for determining an order in which to test child nodes of a (and in embodiments each) parent node of the ray tracing acceleration data structure is selected, and ordering information indicative of the selected ordering strategy is stored in association with the (respective) parent node, e.g. and in embodiments, when generating the ray tracing acceleration data structure. (As will be discussed further below, the ordering information may indicate the selected ordering strategy that is to be used to determine a child node testing order when traversing the ray tracing acceleration data structure, or may indicate a child node testing order that has been determined using the selected ordering strategy when generating the ray tracing acceleration data structure.) Then, when the parent node is encountered during ray traversal of the ray tracing acceleration data structure, the ordering information can be used so as to test child nodes of the parent node in an order determined in accordance with the selected ordering strategy.

As will be discussed in more detail below, this can allow different child node testing ordering strategies to be used in different situations, e.g. for different parent nodes of a ray tracing acceleration data structure and/or for different types of rays being traced. This can facilitate (further) optimisation and acceleration of ray tracing acceleration data structure traversal.

It will be appreciated, therefore, that the technology described herein can provide an improved graphics processing system and ray tracing method.

The graphics processing system should, and in embodiments does, comprise a graphics processor (GPU). The graphics processing system may further comprise a host processor, e.g. a central processing unit (CPU). The host processor (e.g. CPU) may execute applications that can require graphics processing by the graphics processor (GPU), and send appropriate commands and data to the graphics processor (GPU) to control it to perform graphics processing operations and to produce graphics processing (render) output required by applications executing on the host processor (CPU).

To facilitate this, the host processor (CPU) in embodiments also executes a driver for the graphics processor (GPU). Thus, in embodiments, the graphics processing system comprises a graphics processor (GPU) that is in communication with a host microprocessor (CPU) that executes a driver for the graphics processor (GPU).

A (each) operation of the technology described herein may be performed by the graphics processor (GPU), and/or host processor (CPU), and/or another component of the graphics processing system, as appropriate. Correspondingly, a (each) circuit of the technology described herein may form part of the graphics processor (GPU), and/or host processor (CPU), and/or another component of the graphics processing system, as appropriate.

For example, selecting an ordering strategy and/or storing ordering information may be performed by the graphics processor (GPU), and/or host processor (CPU), and/or another component of the graphics processing system. Thus, the processing circuit may be part of the graphics processor (GPU) and/or host processor (CPU), e.g. the driver, and/or another data processor.

In embodiments, (at least) ray tracing/acceleration data structure traversal is performed by a (the) graphics processor (GPU). Thus, in embodiments, (at least) the ray tracing circuit is part of a (the) graphics processor (GPU).

Thus, another embodiment of the technology described herein comprises a method of operating a graphics processor that is operable to perform ray tracing using a ray tracing acceleration data structure that comprises a plurality of nodes, wherein each node of the plurality of nodes represents a respective volume, and the plurality of nodes includes at least one parent node in association with which ordering information is stored that is indicative of a selected ordering strategy for determining an order in which to test rays against child nodes of the parent node;
the method comprising tracing a ray by:
traversing the ray tracing acceleration data structure and testing the ray against nodes of the ray tracing acceleration data structure to determine whether the ray intersects volumes represented by the nodes; and
when it is determined that the ray intersects a volume represented by a parent node for which ordering information is stored:
   determining, using the stored ordering information, an order in which to test the ray against child nodes of the parent node; and
   causing the ray to be tested against child nodes of the parent node in accordance with the determined order.

Another embodiment of the technology described herein comprises a graphics processor that is operable to perform ray tracing using a ray tracing acceleration data structure that comprises a plurality of nodes, wherein each node of the plurality of nodes represents a respective volume, and the plurality of nodes includes at least one parent node in association with which ordering information is stored that is indicative of a selected ordering strategy for determining an order in which to test rays against child nodes of the parent node;
the graphics processor comprising:
a ray tracing circuit operable to trace a ray by traversing a ray tracing acceleration data structure and testing the ray against nodes of the ray tracing acceleration data structure to determine whether the ray intersects volumes represented by the nodes; and
an ordering circuit operable to, when it is determined by the ray tracing circuit that a ray intersects a volume represented by a parent node for which ordering information is stored:
   determine, using the stored ordering information, an order in which to test the ray against child nodes of the parent node; and
   cause the ray to be tested against child nodes of the parent node in accordance with the determined order.

The ray tracing circuit and the ordering circuit may comprise separate circuits, or may be at least partially formed of shared processing circuits. For example, the ray tracing circuit may comprise the ordering circuit.

These embodiments can, and in embodiments do, include any one or more or all of the optional features described herein, as appropriate. For example, the graphics processor may (comprise a (the) processing circuit operable to) select an ordering strategy and store ordering information.

In embodiments of the technology described herein, the graphics processing system/processor is operable to perform ray tracing, e.g. and in embodiments, in order to generate a render output, such as a frame for display, e.g. that represents a view of a scene comprising one or more objects. The graphics processing system/processor may typically generate plural render outputs, e.g. a series of frames.

A render output will typically comprise an array of data elements (sampling points) (e.g. pixels), for each of which appropriate render output data (e.g. a set of colour value data) is generated by the graphics processing system/processor. A render output data may comprise colour data, for example, a set of red, green and blue, RGB values and a transparency (alpha, a) value.

The graphics processing system/processor may carry out ray tracing graphics processing operations in any suitable and desired manner. The graphics processing system/processor may comprise one or more programmable execution units (e.g. shader cores) operable to execute programs to perform graphics processing operations, and ray-tracing based rendering may be triggered and performed by a programmable execution unit of the graphics processing system/processor executing a graphics processing (e.g. shader) program that causes the programmable execution unit to perform ray tracing rendering processes.

The graphics processing system/processor may trace rays individually, or trace a group of plural rays together, e.g. such that the rays of a group visit nodes of the ray tracing acceleration data structure in the same order.

The graphics processing system/processor (comprises a ray tracing circuit that) is operable to perform ray tracing by traversing a ray tracing acceleration data structure. A (the) ray tracing acceleration data structure may be generated by the same graphics processor that then traverses the ray tracing acceleration data. Alternatively, a (the) ray tracing acceleration data structure may be generated by a different data processor to the graphics processor that traverses the ray tracing acceleration data. For example, a ray tracing acceleration data structure may be generated the host processor, e.g. CPU, or another processor, of a data processing system. In embodiments, selecting an ordering strategy and storing ordering information is performed as part of generation of the ray tracing acceleration data structure.

Thus, another embodiment of the technology described herein comprises a method of generating a ray tracing acceleration data structure for use by a graphics processor; the method comprising:
generating and storing a ray tracing acceleration data structure that comprises a plurality of nodes, wherein each node of the plurality of nodes represents a respective volume, and the plurality of nodes includes at least one parent node that is associated with a respective set of child nodes; and
for at least one parent node of the ray tracing acceleration data structure:
   selecting an ordering strategy for determining an order in which to test rays against child nodes of the parent node; and
   storing, in association with the parent node, ordering information indicative of the selected ordering strategy.

Another embodiment of the technology described herein comprises an apparatus operable to generate a ray tracing acceleration data structure for use by a graphics processor; the apparatus comprising:
a ray tracing acceleration data structure generating circuit operable to generate and store a ray tracing acceleration data structure that comprises a plurality of nodes, wherein each node of the plurality of nodes represents a respective volume, and the plurality of nodes includes at least one parent node that is associated with a respective set of child nodes; and
a processing circuit operable to, for at least one parent node of the ray tracing acceleration data structure:
   select an ordering strategy for determining an order in which to test rays against child nodes of the parent node; and
   store, in association with the parent node, ordering information indicative of the selected ordering strategy.

The ray tracing acceleration data structure generating circuit and the processing circuit may comprise separate circuits, or may be at least partially formed of shared processing circuits. For example, the ray tracing acceleration data structure generating circuit may comprise the processing circuit.

These embodiments can, and in embodiments do, include any one or more or all of the optional features described herein, as appropriate.

Typically in ray tracing, one or more rays are used to render a (each) sampling position in the render output, and for each ray being traced, it is determined whether/which geometry that is defined for the render output is intersected by the ray. Geometry determined to be intersected by a ray may be further processed, e.g. in order to determine a colour for the sampling position in question.

The geometry to be processed to generate a render output may comprise any suitable and desired graphics processing geometry. In embodiments, the geometry comprises graphics primitives, in embodiments in the form of polygons, such as triangles, or bounding box primitives.

Determining whether/which geometry is intersected by a ray can be performed in any suitable and desired manner. In general, there may be many millions of graphics primitives within a given scene, and millions of rays to be tested, such that it is not normally practical to test every ray against each and every graphics primitive. To speed up the ray tracing operation, embodiments of the technology described herein use a ray tracing acceleration data structure, such as a bounding volume hierarchy (BVH), that is representative of the distribution of the geometry in the (e.g.) scene that is to be rendered to determine the intersection of rays with geometry (e.g. objects) in the scene being rendered (and then render sampling positions in the output rendered frame representing the scene accordingly).

Ray tracing according to embodiments of the technology described herein therefore generally comprises (the ray tracing circuit) performing a traversal of the ray tracing acceleration data structure, which traversal involves testing rays for intersection with volumes represented by different nodes of the ray tracing acceleration data structure in order to determine which geometry may be intersected by which rays for a sampling position in the render output, and which geometry therefore may need to be further processed for the rays for the sampling position.

A ray tracing acceleration data structure can be arranged in any suitable and desired manner. In embodiments, the ray tracing acceleration data structure comprises a tree structure that is configured such that each end (e.g. leaf) node of the tree structure represents a set of geometry (e.g. primitives) defined within the respective volume that the end (e.g. leaf) node corresponds to, and with the other (non-leaf) nodes representing hierarchically-arranged larger volumes up to a root node at the top level of the tree structure that represents an overall volume for the render output (e.g. scene) in question that the tree structure corresponds to.

Each non-leaf node is therefore in embodiments a parent node for a respective set of plural child nodes with the parent node volume encompassing the volumes of its respective child nodes. In embodiments, each (non-leaf) parent node is associated with a respective plurality of child node volumes, each representing a (in embodiments non-overlapping) sub-volume within the overall volume represented by the (non-leaf) parent node in question.

Thus, at least one of the nodes of the ray tracing acceleration data structure is associated with a respective set of plural child nodes. In embodiments, there are multiple such parent nodes in the ray tracing acceleration data structure.

Thus, in embodiments, traversal of the ray tracing acceleration data structure comprises (the ray tracing circuit) proceeding down the “branches” of the tree structure and testing the rays against the child volumes associated with a node at a first level of the tree structure to thereby determine which child nodes in the next level of the tree structure should be tested, and so on, down to the level of the respective end (e.g. leaf) nodes at the end of the branches of the tree structure.

A ray tracing acceleration data structure could comprise, e.g. a single tree structure (e.g. BVH) representing the entirety of a scene being rendered. In embodiments, a ray tracing acceleration data structure comprises multiple “levels” of tree structures (e.g. BVHs).

For example, in embodiments, the ray tracing acceleration data structure comprises one or more “lowest level” tree structures (e.g. BVHs) (which may also be referred to as a “bottom level acceleration structure (BLAS)”), that each represent a respective instance or object within a scene to be rendered, and a “highest level” tree structure (e.g. BVH) (which may also be referred to as a “top level acceleration structure (TLAS)”) that refers to the one or more “lowest level” tree structures. In this case, each “lowest level” tree structure may comprise end (e.g. leaf) nodes that represent a set of geometry (e.g. primitives) associated with the respective instance or object, and the “highest level” tree structure may comprise end (e.g. leaf) nodes that point to, e.g. the root node of, one or more of the one or more “lowest level” tree structures.

In embodiments, each “lowest level” tree structure (e.g. BLAS) is defined in a space that is associated with the respective instance or object, e.g. a model space, whereas the “highest level” tree structure (e.g. TLAS) is defined in a space that is associated with the entire scene, e.g. a world space. In this case, each “highest level” tree structure end (e.g. leaf) node may include information indicative of an appropriate transformation between respective spaces. Correspondingly, traversal of the ray tracing acceleration data structure may comprise, when an end (e.g. leaf) node of the “highest level” tree structure is reached, applying a transformation indicated by the end (e.g. leaf) node, and then beginning traversal of the corresponding “lowest level” tree structure.

Once it has been determined by performing a traversal operation for a ray which end (e.g. leaf) nodes represent geometry that may be intersected by a ray, the actual geometry intersections for the ray for the geometry that occupies the volumes associated with the intersected end (e.g. leaf) nodes can be determined accordingly, e.g. by testing the ray for intersection with the individual units of geometry (e.g. primitives) defined for the render output (e.g. scene) that occupy the volumes associated with the end (e.g. leaf) nodes.

Thereafter, once the geometry intersections for the rays being used to render a sampling position have been determined, it can then be (and in embodiments is) determined what appearance the sampling position should have, and the sampling position rendered accordingly.

Thus, in embodiments, the (e.g. ray tracing circuit of the) graphics processor/system is operable to perform ray-volume intersection tests in which it is determined whether a ray intersects a volume represented by a node of the ray tracing acceleration data structure, and ray-geometry (e.g. primitive) intersection tests in which it is determined whether a ray intersects geometry (e.g. a primitive) occupying a volume represented by a node of the ray tracing acceleration data structure.

Ray-volume intersection tests and/or ray-geometry (e.g. primitive) intersection tests may be performed by a programmable execution unit of the graphics processor/system executing an appropriate program. In embodiments, the (e.g. ray tracing circuit of the) graphics processor/system comprises a ray-volume intersection testing circuit that is operable to perform ray-volume intersection tests, and that is in embodiments a (substantially) fixed function circuit. In embodiments, the (e.g. ray tracing circuit of the) graphics processor/system comprises a ray-geometry (e.g. primitive) intersection testing circuit that is operable to perform ray-geometry (e.g. primitive) intersection tests, and that is in embodiments a (substantially) fixed function circuit.

In embodiments, the execution of an appropriate program instruction triggers the programmable execution unit to message the ray-volume intersection testing circuit to cause the ray-volume intersection testing circuit to perform a ray-volume intersection test. In embodiments, the execution of an appropriate program instruction triggers the programmable execution unit to message the ray-geometry (e.g. primitive) intersection testing circuit to cause the ray-geometry (e.g. primitive) intersection testing circuit to perform a ray-geometry (e.g. primitive) intersection test.

Other arrangements are possible.

In embodiments of the technology described herein, a child node ordering strategy is selected for a parent node, and an order in which to test a ray against child nodes of the parent node is determined using the selected child node ordering strategy. Where plural rays are traced together (such that they visit nodes in the same order), an order in which to test a group of rays against child nodes of a parent node may be determined using a selected child node ordering strategy.

A child node ordering strategy may be any suitable process by which an order in which to test a ray (or rays) against child nodes of a parent node can be determined. In embodiments, a child node ordering strategy is based on determining properties of rays and/or nodes, and ordering child nodes based on the determined properties.

For example, and in embodiments, a child node ordering strategy is based on distances between a ray (or rays) and child node volumes. For example, and as mentioned above, a child node ordering strategy may be: (i) a “front-to-back” ordering strategy in which child nodes that represent volumes that are closer to a ray's origin are tested before child nodes that represent volumes that are further away from the ray's origin; or (ii) a “back-to-front” ordering strategy in which child nodes that represent volumes that are further away from a ray's origin are tested before child nodes that represent volumes that are nearer to the ray's origin.

Thus, in embodiments, determining a child node testing order comprises determining information representing a (e.g. shortest) distance between a ray's origin and a (each) (intersected) child node volume, and ordering the child nodes based on the distances (e.g. smallest to largest distance, or largest to smallest distance).

In embodiments, a child node ordering strategy is based on child node sizes. For example, as mentioned above, a child node ordering strategy may be a “largest-to-smallest” ordering strategy in which child nodes that represent larger volumes are tested before child nodes that represent smaller volumes. Other child node size-based ordering strategies, such as “smallest-to-largest”, are possible.

Thus, in embodiments, determining a child node testing order comprises determining information representing a size of a (each) (intersected) child node volume, and ordering the child nodes based on the sizes (e.g. largest to smallest size).

Information representing a size of a child node volume may, for example, comprise a length, area or volume of the child node volume. In embodiments, information representing a size of a child node volume comprises a surface area of the child node volume. Thus, embodiments comprise determining information representing a surface area of a (each) (e.g. intersected) child node volume, and ordering the child nodes based on the surface areas (e.g. largest to smallest surface area).

In embodiments, a child node ordering strategy is based on a frequency of previous ray visits to, or intersections with, a child node. For example, child nodes that have been visited/intersected more often may be tested before child nodes that have been visited/intersected less often. Thus, in embodiments, determining a child node testing order comprises recording a number of ray visits to, or intersections with, a (each) child node, and ordering the child nodes based on the number of visits/intersections.

Other child node ordering strategies, e.g. based on other ray and/or node properties and heuristics, are possible.

It will be appreciated here than when using an ordering strategy that is based on ray properties (such as “front-to-back” or “back-to-front”), an order in which to test a ray against child nodes may typically be only determinable when tracing the ray. Thus, in embodiments, the stored ordering information indicates the selected ordering strategy that is to be used to determine a child node testing order (when traversing the ray tracing acceleration data structure), and determining a child node testing order using the stored ordering information comprises determining the order using the ordering strategy indicated by the stored ordering information.

On the other hand, when using an ordering strategy that is based (only) on child node properties (such as “largest-to-smallest”), an order in which to test a ray against child nodes may be determinable when tracing the ray or prior to tracing the ray, e.g. when generating the ray tracing acceleration data structure. Thus, in embodiments, a child node ordering strategy is selected and a child node testing order is determined using the selected ordering strategy when generating the ray tracing acceleration data structure. In embodiments, the stored ordering information indicates (e.g. the selected ordering strategy and) the child node testing order determined using the selected ordering strategy, and determining a child node testing order using the stored ordering information comprises determining the order indicated by the stored ordering information. The determined child node testing order may, for example and in embodiments, be indicated by an order in which child nodes are stored.

In embodiments, the ordering information stored in association with a parent node comprises: child node testing order information indicating a child node testing order determined when generating the ray tracing acceleration data structure; and one or more flags indicating whether to test rays against child nodes of the parent node in accordance with the child node testing order indicated by the child node testing order information (or whether to use an ordering strategy indicated by the ordering information to determine a child node testing order when traversing the ray tracing acceleration data structure).

An ordering strategy may be specified for any ray being traced. As mentioned above, the Applicant has recognised that an optimum strategy for determining an order in which to test child nodes can vary depending on the type of ray being traced, e.g. an optimum ordering strategy may be different for “closest-hit” rays and “visibility” rays. To allow different ordering strategies to be used for different types of ray, an ordering strategy may be specified that applies (only) to a particular type of ray.

Thus, in embodiments, selecting an ordering strategy comprises selecting an ordering strategy for rays of a particular type, the stored ordering information is indicative of the ordering strategy selected for rays of the particular type, and the stored information is used to determine an order in which to test rays of the particular type.

Different ordering strategies could be selected, stored and used for different types of rays. The Applicant has recognised, however, that when a “closest-hit” ray is being traced, it may typically be desirable to minimise the time taken to find intersecting geometry (if any) that is closest to the ray's origin. Accordingly, in the case of a closest-hit ray, it may typically be desired to e.g. always select a “front-to-back” ordering strategy, e.g. such that it may not be necessary to specify the ordering strategy for closest-hit rays. Thus, in embodiments, ordering information is not stored or used for rays of a type other than the particular type, e.g. closest-hit rays.

On the other hand, the Applicant has recognised that an optimum strategy for determining an order in which to test visibility rays against child nodes can vary depending on factors such as the nature and content of the scene being rendered. Thus, in embodiments, an ordering strategy is selected (only) for visibility rays, the stored ordering information is indicative of the ordering strategy selected for (only) visibility rays, and the stored information is used to determine an order in which to test (only) visibility rays.

A child node ordering strategy can be selected (e.g. for rays of a particular type, e.g. visibility rays) in any suitable manner. A child node ordering strategy may be selected for plural different parent nodes, e.g. each parent node, of the ray tracing acceleration data structure. In embodiments, different child node ordering strategies are selected for different parent nodes of the ray tracing acceleration data structure.

A child node ordering strategy should be, and in embodiments is, selected from a set of plural possible different child node ordering strategies, e.g. and in embodiments, including one or more, such as all, of: (i) “front-to-back”; (ii) “back-to-front”; and (iii) “largest-to-smallest”. Other ordering strategies, such as “smallest-to-largest”, are possible.

In embodiments, a child node ordering strategy is selected so as to (try to) reduce (e.g. minimise) a time taken to trace a ray. For example, in the case of a visibility ray, it may typically be desirable to minimise the time taken to find any intersecting geometry (e.g., regardless of whether that geometry is closest to the ray's origin or not). Accordingly, in the case of a visibility ray, it may typically be advantageous to select an ordering strategy in which child volumes that are more likely to contain any intersecting geometry are tested before child node volumes that are less likely to contain any intersecting geometry.

Thus, in embodiments, a child node ordering strategy (e.g. for visibility rays) is selected based on a likelihood that child node volumes contain (any) interesting geometry. In embodiments, selecting an ordering strategy (for visibility rays) comprises selecting an ordering strategy that is expected to result in child nodes that are more likely to contain any intersecting geometry being tested before child nodes that are less likely to contain any intersecting geometry.

For example, and in embodiments, where a large occluding object is likely to be present far from a ray's origin, a “back-to-front” order may be selected. Where a large occluding object is likely to be present near to a ray's origin, a “front-to-back” order may be selected. Where the likelihood that a child node contains any intersecting geometry can be assumed to be proportional to the size of the child node, a “largest-to-smallest” order may be selected.

Other factors may also or instead be considered when selecting a child node ordering strategy. For example, the processing requirements for determining a child node order using the ordering strategy may be taken into account. For example, where it is expected that the ray tracing acceleration data structure will be re-built relatively frequently (e.g. in the case of a dynamic scene), an ordering strategy may be selected in which child node order can (and will) be determined during acceleration data structure traversal, rather than generation (e.g. front-to-back or back-to-front).

On the other hand, where it is expected that the ray tracing acceleration data structure will be re-built less frequently (e.g. in the case of a static scene), an ordering strategy may be selected in which child node order can (and will) be determined during acceleration data structure generation (e.g. largest-to-smallest).

Thus, in embodiments, an ordering strategy is selected based on whether the ordering strategy will be used to determine an order in which to test rays against child nodes when generating the ray tracing acceleration data structure or when traversing the ray tracing acceleration data structure.

Once an order has been determined, a ray may be tested in accordance with the determined order in any suitable manner. In embodiments, the (ray tracing circuit of the) graphics processor/processing system makes use of a test (traversal) record to manage its traversal and testing operations. A separate test record may be maintained for each ray being traced, or a combined test record may be maintained, e.g. for a group of plural rays being traced together. In embodiments, a test record comprises a list of entries each indicating a test that may need to be performed to trace a ray.

In embodiments, the record is stored in the form of a suitable stack, and is in embodiments managed using a “last-in-first-out” scheme, e.g. in the normal way for a stack. Thus, in embodiments, a test record (stack) entry indicating a test (e.g. indicating a node of the ray tracing acceleration data structure (e.g. BVH)) is pushed to a stack for a ray (by the ray tracing circuit) when it is determined that the ray may need to be tested (e.g. against the node), and it is determined (by the ray tracing circuit) which test should next be performed (e.g. which node the ray should next be tested against) by popping a (the top) test record entry from the stack for the ray, and determining that the ray should next be tested in accordance with the (e.g. against the node indicated by the) popped test record entry.

In embodiments, when a ray is found to intersect a parent node volume that is associated with a set of child nodes, the ray is tested for intersection with the volumes that the child nodes represent (e.g. by the ray-volume intersection testing circuit), and when the ray is found to intersect two or more of the child nodes, test record (stack) entries corresponding to the two or more child nodes are pushed to the record (stack) for the ray in accordance with the determined child node processing order, i.e. such that the test record (stack) entries will be popped and processed in the determined order.

As described above, the technology described herein can be implemented for any suitable type of ray tracing acceleration data structure, such as comprising a tree structure. A ray tracing acceleration data structure could, for example, comprise a binary tree, e.g. with each parent node having (exactly) two child nodes. However, the technology described herein may be particularly advantageous where a (each) parent node has a relatively larger number of child nodes (i.e. corresponding to a relatively “wide” tree structure). Thus, in embodiments, a (each) parent node has more than two child nodes, such as three, four, five, six, or more, child nodes.

Each embodiment of the technology described herein can, and in embodiments does, include one or more, and in embodiments all, features of other embodiments of the technology described herein, as appropriate.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the data/graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The graphics processor and/or graphics processing system may also comprise, and/or be in communication with, one or more memories and/or memory devices that store the data described herein, and/or store software (e.g. (shader) program) for performing the processes described herein. The processor and/or system may also be in communication with and/or include a host microprocessor, and/or with a display for displaying images based on data generated by the processor/system.

The technology described herein can be used for all forms of input and/or output that a graphics processor may use or generate. For example, the graphics processor may execute a graphics processing pipeline that generates frames for display, render-to-texture outputs, etc. . . . . The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the graphics processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc. . . . .

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

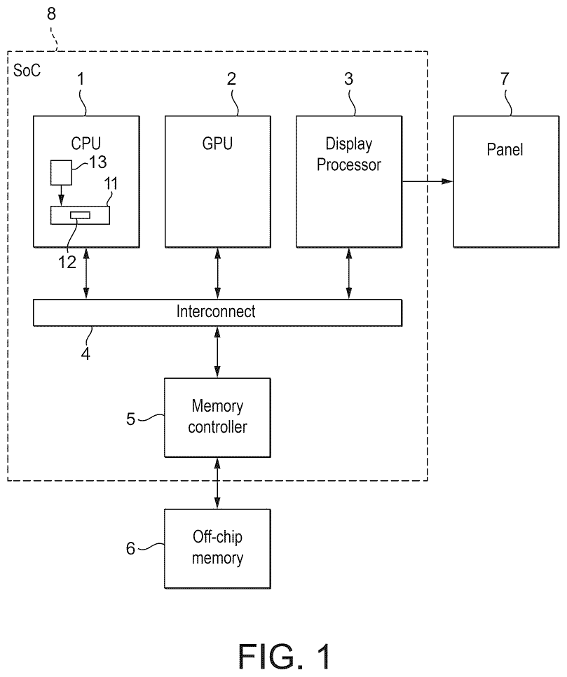

The present embodiments relate to the operation of a graphics processor, e.g. in a graphics processing system as illustrated in FIG. 1, when performing rendering of a scene to be displayed using a ray tracing-based rendering process.

Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of (zero or more) objects within the scene which a ray passing through the sampling position intersects.

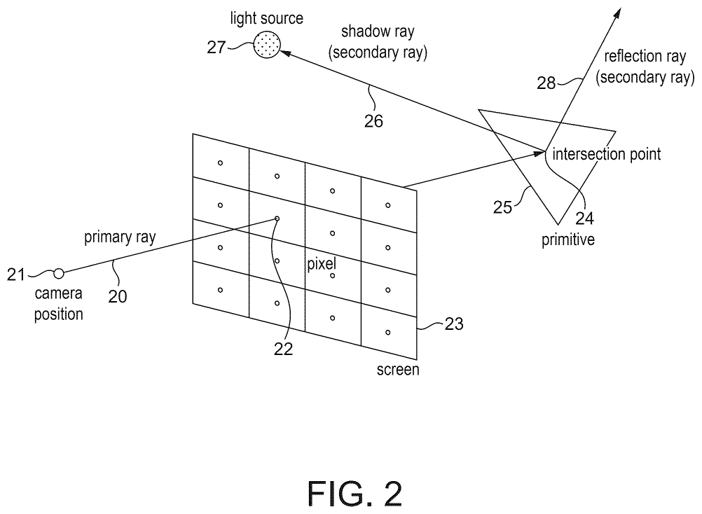

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object, which in this case is represented by a triangle primitive 25, in the scene is identified. This first intersection will be with the object in the scene closest to the sampling position.

A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

Thus, different types of rays may be traced, depending on the scene, etc. . . . . Primary, reflection and refraction rays may be referred to as “closest-hit rays”, since they are typically traced until intersecting geometry closest to the ray's origin is found (or until it is determined that the ray does not intersect any geometry). On the other hand, shadow rays may be referred to as “first-hit rays” or “visibility rays”, as they can typically be terminated as soon as they are found to intersect any geometry (or until it is determined that the ray does not intersect any geometry).

In order to facilitate such ray tracing processing, in the present embodiments, acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered).

In the present embodiments, a ray tracing acceleration data structure is in the form of one or more Bounding Volume Hierarchy (BVH) trees. The use of BVH trees allows and facilitates testing a ray against a hierarchy of bounding volumes until a leaf node is found. It is then only necessary to test the geometry associated with the particular leaf node for intersection with the ray.

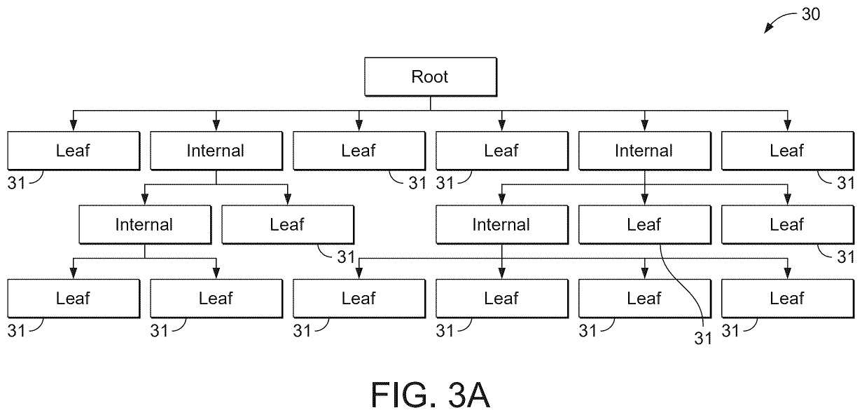

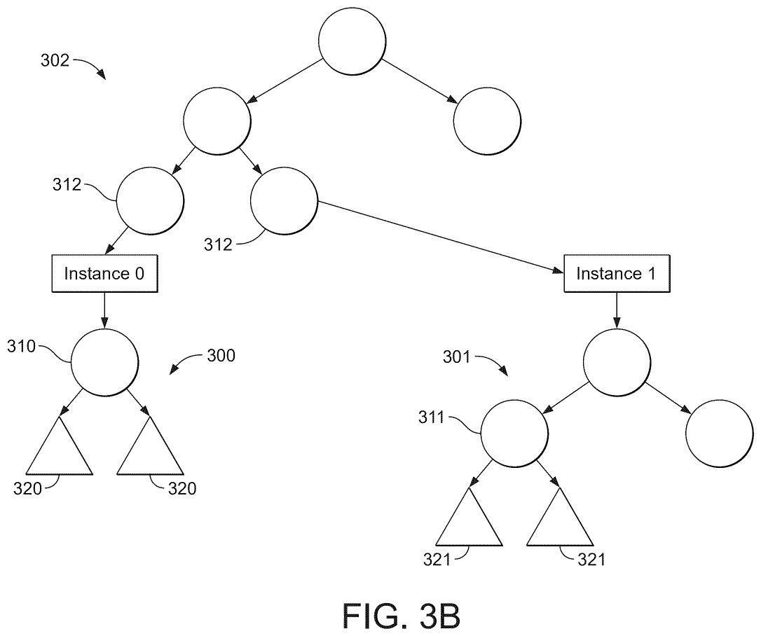

FIG. 3A shows an exemplary BVH tree 30, constructed by enclosing a volume in an axis-aligned bounding volume (AABV), e.g. a cube, and then recursively subdividing the bounding volume into successive sub-AABVs according to any suitable and desired subdivision scheme, until a desired smallest subdivision (volume) is reached.

In this example, the BVH tree 30 is a relatively “wide” tree wherein each bounding volume is subdivided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest subdivided volume, and any parent node representing, and being associated with, the volume of its child nodes.

A complete scene may be represented by a single BVH tree, e.g. with the tree storing the geometry for the scene in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

In the present embodiments, a two-level ray tracing acceleration data structure is used. FIG. 3B shows an exemplary two-level ray tracing acceleration data structure in which each instance or object is associated with a respective bottom-level acceleration structure (BLAS) 300, 301, which in the present embodiments is in the form of a respective BVH tree that stores geometry in model space, with each leaf node 310, 311 of the BVH tree representing a unique subset of primitives 320, 321 defined for the instance or object falling within the corresponding volume.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in a “top-level” (e.g. world) space and is in the form of a BVH tree having leaf nodes 312 that each point to one or more of the bottom-level acceleration structures (BLAS) 300, 301.

Other forms of ray tracing acceleration data structure would be possible.

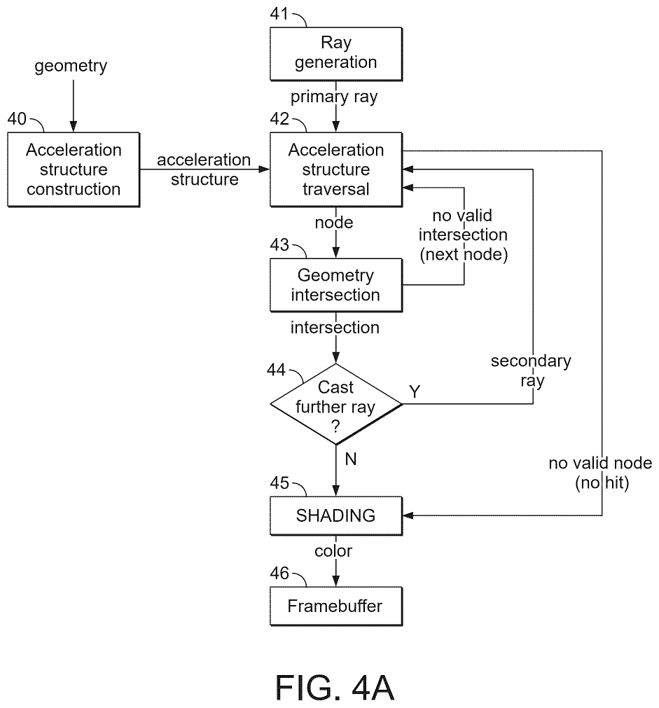

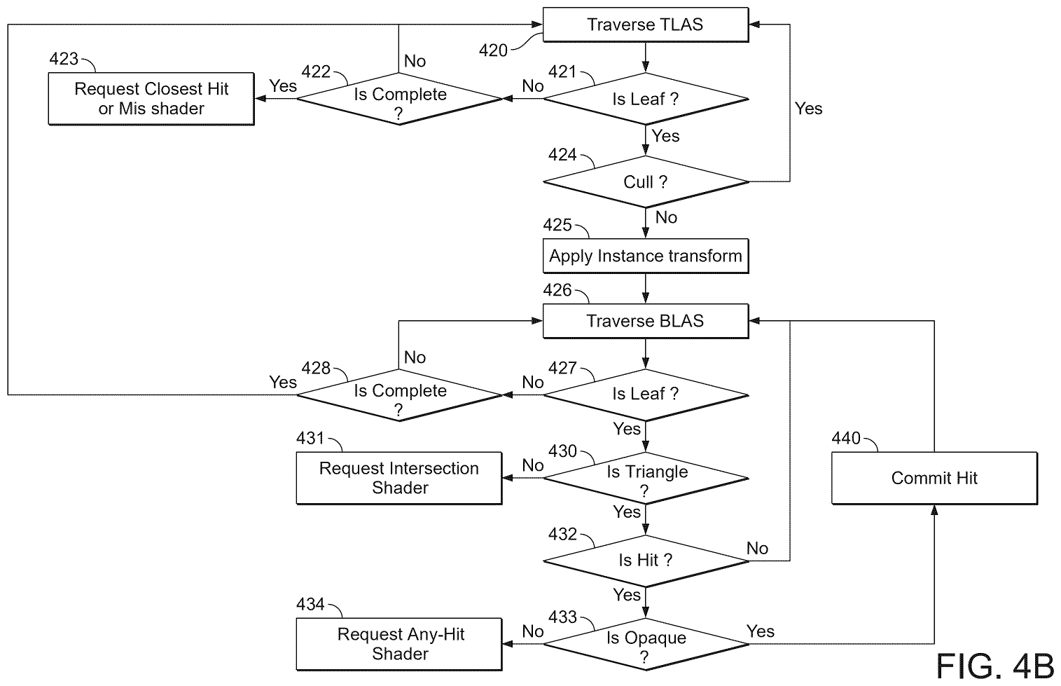

FIG. 4A is a flow chart showing an overall ray tracing process that may be performed on and by the graphics processor 2.

First, the geometry of the scene is analysed and used to obtain an acceleration data structure (step 40), for example in the form of one or more BVH tree structures, as discussed above. This can be done in any suitable and desired manner, for example by means of an initial processing pass on the graphics processor 2.

A primary ray is then generated, passing from a camera through a particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified.

When geometry that the ray intersects is identified, it is then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used.

Thus, as shown in FIG. 4A, one or more secondary rays may be generated emanating from the intersection point (e.g. a shadow ray(s), a refraction ray(s) and/or a reflection ray(s), etc.). Steps 42, 43 and 44 are then performed in relation to each secondary ray.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc. . . . . The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements are possible.

This process is performed for each sampling position to be considered in the image plane (frame). Once the final output value for the sampling position in question has been generated, the processing in respect of that sampling position is completed. A next sampling position may then be processed in a similar manner, and so on, until all the sampling positions for the frame have been appropriately shaded. The frame may then be output, e.g. for display, and the next frame to be rendered processed in a similar manner, and so on.

FIG. 4B is a flow chart showing in more detail acceleration structure traversal in the case of a two-level acceleration data structure, e.g. as described above with reference to FIG. 3B. As shown in FIG. 4B, in this case, acceleration structure traversal begins with TLAS traversal (step 420), and TLAS traversal continues in search of a TLAS leaf node (steps 421, 422). If no TLAS leaf node can be identified, a “default” shading operation (“miss shader”) may be performed (step 423), e.g. as described above.

When (at step 421) a TLAS leaf node is identified, it is determined whether that leaf node can be culled from further processing (step 424). If it can be culled from further processing, the process returns to TLAS traversal (step 420).

If the TLAS leaf node cannot be culled from further processing, instance transform information associated with the leaf node is used to transform the ray to the appropriate space for BLAS traversal (step 425). BLAS traversal then begins (step 426), and continues in search of a BLAS leaf node (steps 427, 428). If no BLAS leaf node can be identified, the process may return to TLAS traversal (step 420).

In the present embodiments, geometry associated with a BLAS leaf node can be in the form of a set of triangle primitives or an axis aligned bounding box (AABB) primitive. When (at step 427) a BLAS leaf node is identified, it is determined whether geometry associated with the leaf node is in the form of a set of triangle primitives or an axis aligned bounding box (AABB) primitive (step 430).

As shown in FIG. 4B, when an axis aligned bounding box (AABB) primitive is encountered, execution of a shader program (“intersection shader”) that defines a procedural object encompassed by the axis aligned bounding box (AABB) is triggered (step 431) to determine whether a ray intersects the procedural object defined by the shader program. On the other hand, when a set of triangle primitives is encountered, determining whether a ray intersects any of the triangle primitives is performed by fixed function circuitry (step 432). Other arrangements would be possible.

If no (valid) triangle primitives which the ray intersects can be identified in the node, the process returns to BLAS traversal (step 426).

If a ray is found to intersect a triangle primitive 25, it is determined whether or not the triangle primitive 25 is opaque (step 433). In the case of the triangle primitive being found to be non-opaque, execution of an appropriate shader program (“any-hit shader”) may be triggered (step 434). Otherwise, in the case of the triangle primitive being found to be opaque, the intersection can be committed without executing a shader program (step 440). Traversal for one or more secondary rays may be triggered, as appropriate, e.g. as discussed above.

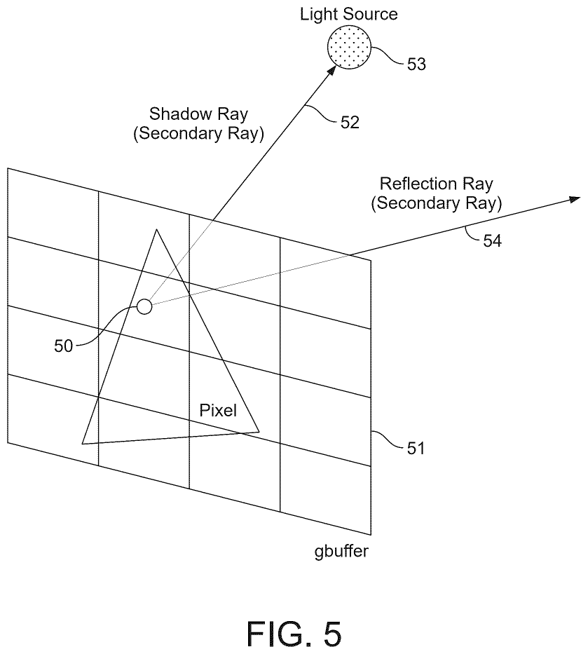

FIG. 5 shows an alternative ray tracing process which may be used in embodiments of the technology described herein, in which only some of the steps of the full ray tracing process described above are performed. Such an alternative ray tracing process may be referred to as a “hybrid” ray tracing process.

In this process, as shown in FIG. 5, the first intersection point 50 for each sampling position in the image plane (frame) is instead determined first using a rasterisation process and stored in an intermediate data structure known as a “G-buffer” 51. Thus, the process of generating a primary ray for each sampling position, and identifying the first intersection point of the primary ray with geometry in the scene, is replaced with an initial rasterisation process to generate the “G-buffer”. The G-buffer includes information indicative of the depth, colour, normal and surface properties (and any other appropriate and desired data, e.g. albedo, etc.) for each first (closest) intersection point for each sampling position in the image plane (frame).

Secondary rays, e.g. shadow ray 52 to light source 53, and reflection ray 54, may then be cast starting from the first intersection point 50, and the shading of the sampling positions determined based on the properties of the geometry first intersected, and the interactions of the secondary rays with geometry in the scene.

Referring to the flowchart of FIG. 4A, in such a hybrid process, the initial pass of steps 41, 42 and 43 of the full ray tracing process for a primary ray will be omitted, as there is no need to cast primary rays and determine their first intersection with geometry in the scene. The first intersection point data for each sampling position is instead obtained from the G-buffer.

The process may then proceed to the shading stage 45 based on the first intersection point for each pixel obtained from the G-buffer, or where secondary rays emanating from the first intersection point are to be considered, these will need to be cast in the manner described by reference to FIG. 4. Thus, steps 42, 43 and 44 will be performed in the same manner as previously described in relation to the full ray tracing process for any secondary rays.

The colour determined for a sampling position will be written to the frame buffer in the same manner as step 46 of FIG. 4A, based on the shading colour determined for the sampling position based on the first intersection point (as obtained from the G-buffer), and, where applicable, the intersections of any secondary rays with objects in the scene, determined using ray tracing.

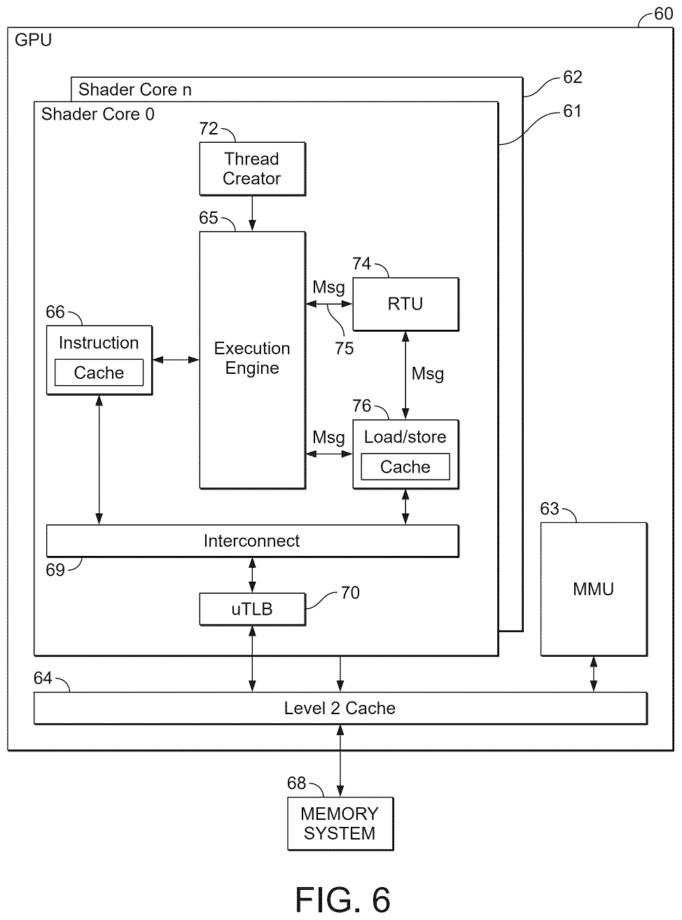

FIG. 6 shows schematically the relevant elements and components of a graphics processor (GPU) 2, 60 of the present embodiments.

As shown in FIG. 6, the GPU 60 includes one or more shader (processing) cores 61, 62 together with a memory management unit (“MMU”) 63 and a level 2 cache 64 which is operable to communicate with an off-chip memory system 68 (e.g. via an appropriate interconnect and (dynamic) memory controller).

FIG. 6 shows schematically the relevant configuration of one shader core 61, but as will be appreciated by those skilled in the art, any further shader cores of the graphics processor 60 will be configured in a corresponding manner.

The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, etc. . . . . The shader cores will process each “item” by means of one or more execution threads which will execute the instructions of the shader program(s) in question for the “item” in question. Typically, there will be multiple execution threads each executing at the same time (in parallel).

FIG. 6 shows the main elements of the graphics processor 60 that are relevant to the operation of the present embodiments. As will be appreciated by those skilled in the art there may be other elements of the graphics processor 60 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 68 (for data loads and stores for programs executed in the programmable execution unit). Again, such data will be fetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered). Accordingly, as shown in FIG. 6, the shader core 61 further comprises a thread creator (generator) 72 operable to generate execution threads for execution by the programmable execution unit 65.

As shown in FIG. 6, the shader core 61 in this embodiment also includes a ray tracing circuit (unit) (“RTU”) 74, which is in communication with the programmable execution unit 65, and which is operable to perform the required ray-volume testing during the ray tracing acceleration data structure traversals (e.g. the operation of steps 420 and 426 of FIG. 4B) for rays being processed as part of a ray tracing-based rendering process, in response to messages 75 received from the programmable execution unit 65.

In the present embodiments the RTU 74 is also operable to perform the required ray-primitive testing (e.g. the operation of step 432 of FIG. 4B). The RTU 74 is also able to communicate with the load/store unit 76 for loading in the required data for such intersection testing.

In the present embodiments, the RTU 74 of the graphics processor is a (substantially) fixed-function hardware unit (circuit) that is configured to perform the required ray-volume and ray-primitive intersection testing during a traversal of a ray tracing acceleration data structure to determine geometry for a scene to be rendered that may be (and is) intersected by a ray being used for a ray tracing operation. However, some amount of configurability may be provided. Other arrangements would be possible. For example, ray-volume and/or ray-primitive intersection testing may be performed by the programmable execution unit 65 (e.g. in software).

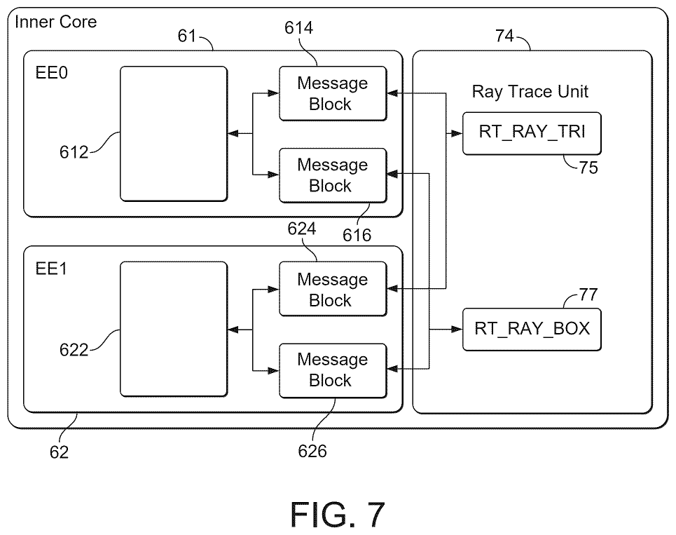

FIG. 7 shows in more detail the communication between the RTU 74 and the shader cores 61, 62, in the present embodiments. As shown in FIG. 7, in the present embodiments, the RTU 74 includes respective hardware circuits for performing the ray-volume testing (RT_RAY_BOX) 77 and for performing the ray-primitive testing (RT_RAY_TRI) 75. The shader cores 61, 62 thus contain appropriate message blocks 614, 616, 624, 626 for messaging the respective ray-volume testing circuit 77 and ray-primitive testing circuit 75 accordingly when it is desired to perform intersection testing during a traversal operation.

In the present embodiments, execution of an appropriate ray-volume testing instruction (‘RT_RAY_BOX’) included in a shader program triggers the execution unit 65 to message the ray-volume intersection testing circuit 77 of the RTU 74 to perform the desired ray-volume testing. Similarly, execution of an appropriate instruction (‘RT_RAY_TRI’) included in a shader program triggers the execution unit to message the ray-primitive intersection testing circuit 75 of the RTU 74 to perform the desired ray-primitive testing.

As shown in FIG. 7, the message blocks communicate with respective local storage 612, 622 of the shader cores 61, 62 so that the result of the intersection testing can be stored locally.

In particular, in the present embodiments the traversal operation is managed using a traversal stack that is maintained in the local storage 612, 622. The local storage 612, 622 can comprise any suitable and desired type of storage, such as registers, RAM, etc. . . . .

A traversal stack includes stack entries that each indicate a node to be visited and tested, with the top entry in the stack indicating the next node to be visited and tested for a ray. The top entry in the stack is accordingly popped to determine the next node to visit and test, and when it is determined that a new node should be visited and tested, a corresponding stack entry is pushed to the stack. The stack is managed using a “last-in-first-out” scheme.

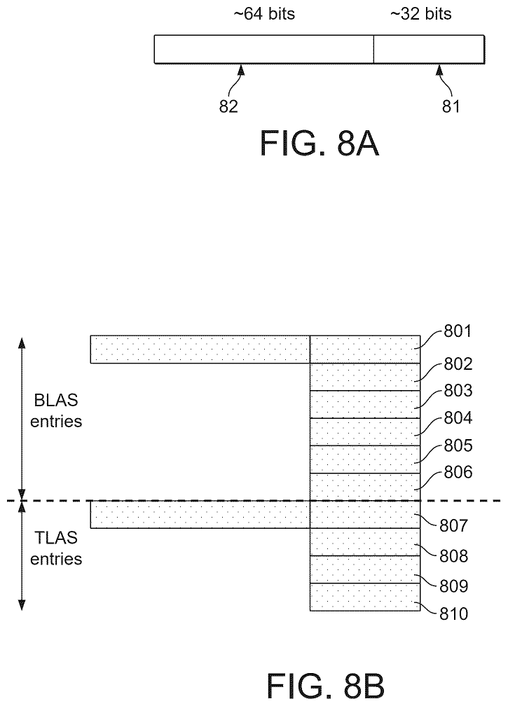

FIG. 8A illustrates an exemplary stack entry, according to embodiments. As shown in FIG. 8A, in the present embodiments, each stack entry includes node information 81 that includes information indicating a volume associated with a node to be tested and any child nodes that are associated with the node. A stack entry that relates to a leaf node further includes leaf information 82 that may indicate geometry represented by the leaf node in question (e.g. in the case of a BLAS leaf node) or references to one or more other (e.g. BLAS) acceleration structures together with shading and transformation information (e.g. in the case of a TLAS leaf node).

As shown in FIG. 8A, in the present embodiments the node information 81 comprises 32 bits, and the leaf information 82 comprises 64 bits. A leaf node stack entry thus comprises 96 bits, whereas an internal node stack entry comprises only 32 bits. Other arrangements are possible.

FIG. 8B illustrates an exemplary stack of entries to be processed by a shader core 61, 62. As shown in FIG. 8B, in this example, the stack includes six stack entries 801-806 for BLAS nodes at the top of the stack, and four stack entries 807-810 for TLAS nodes at the bottom of the stack.

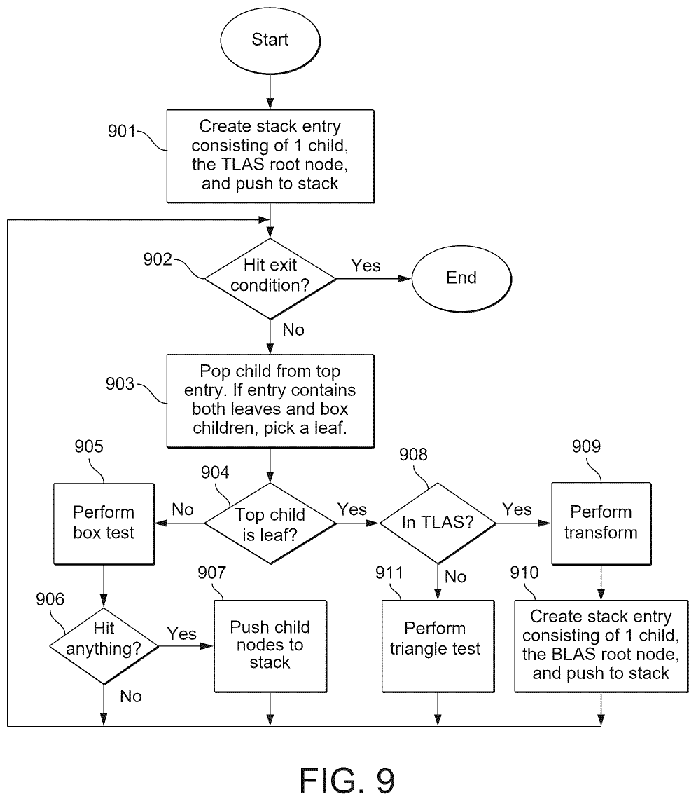

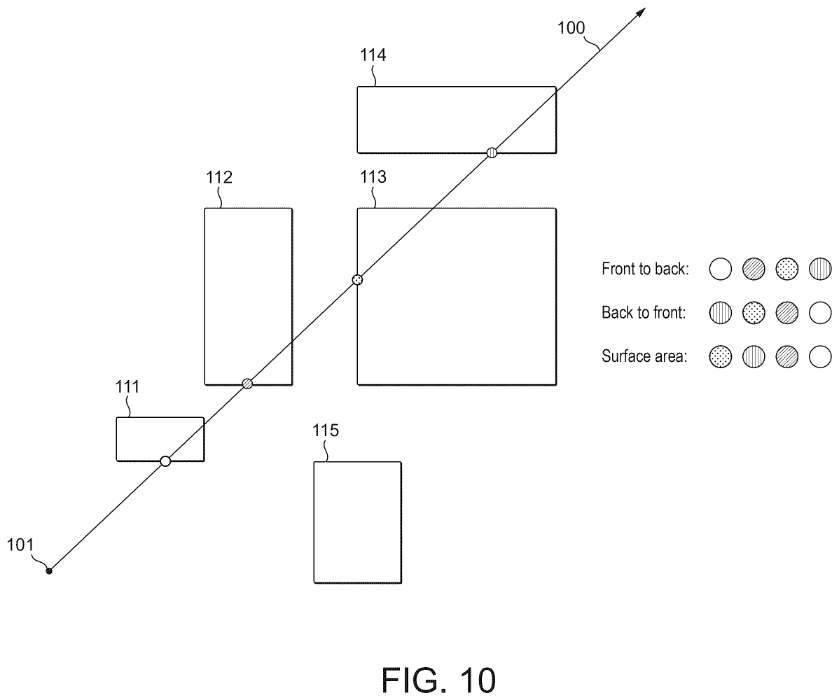

FIG. 9 is a flowchart showing the operation of a shader core 61, 62 of the graphics processor 2, 60 when performing a ray tracing-based rendering process in embodiments of the technology described herein. FIG. 9 shows the operation in respect of a given ray, and this operation will be performed for each ray being traced.

As shown in FIG. 9, the process begins with a first entry being pushed to the stack corresponding to the TLAS root node (step 901). There is then a check to determine whether tracing for the current ray is complete (step 902), and if not, the process continues with the top entry in the stack being popped (step 903) for processing.

As the TLAS root node should be an internal node (i.e. not a leaf node) (at step 904), it is subjected to a ray-volume intersection test (at step 905), and for any child nodes determined to be intersected (at step 906), a corresponding stack entry is pushed to the stack (at step 907). The process then returns to step 902 to determine whether tracing for the current ray is complete, and if not, the process continues with the top entry in the stack being popped (step 903) for processing.

As shown in FIG. 9, when a TLAS leaf node is reached (step 908), transformation information associated with the leaf node is used to transform the ray (step 909), and a stack entry corresponding to a BLAS root node is pushed to the stack (step 910). The process then returns to step 902 to determine whether tracing for the current ray is complete, and if not, the process continues with the top entry in the stack being popped (step 903) for processing.

As a BLAS root node should be an internal node (i.e. not a leaf node) (at step 904), it is subjected to a ray-volume intersection test (at step 905), and for any child nodes determined to be intersected (at step 906), a corresponding stack entry is pushed to the stack (step 907). The process then returns to step 902 to determine whether tracing for the current ray is complete, and if not, the process continues with the top entry in the stack being popped (step 903) for processing.

As shown in FIG. 9, when a BLAS leaf node is reached (step 908), the geometry associated with the leaf node is subjected to a ray-primitive intersection test (at step 911). The process then returns to step 902 to determine whether tracing for the current ray is complete, and if not, the process continues with the top entry in the stack being popped (step 903) for processing.

In the present embodiments, the ray tracing unit (RTU) 74 may attempt to optimise the order in which stack entries are pushed to the stack, and so subsequently processed.

In particular, the acceleration structure traversal order may be configured such that when there is a choice between visiting a leaf node or an internal node of an acceleration structure next, the leaf node is visited next. To facilitate this, as illustrated in FIG. 8B, the ray tracing unit (RTU) 74 maintains any BLAS leaf node entry 801 as the topmost BLAS stack entry (such that the BLAS leaf node entry 801 will be popped from the stack and processed before BLAS internal node stack entries 802-806), and any TLAS leaf node entry 807 as the topmost TLAS stack entry (such that the TLAS leaf node entry 807 will be popped from the stack and processed before TLAS internal node stack entries 808-810).

The ray tracing unit (RTU) 74 may also attempt to optimise the order in which internal node stack entries 802-806, 808-810 are processed. To do this, stack entries for child nodes of an internal (parent) node determined to be intersected by a ray may be pushed to the stack so that they are subsequently processed in a “front-to-back” order. This is illustrated schematically in FIG. 10.

FIG. 10 illustrates an exemplary set of five child nodes 111-115 of a parent internal node (not shown). In this example, child nodes 111-114 are determined to be intersected by ray 100, and so a stack entry corresponding to each child node 111-114 is pushed to the stack for processing. (In this example, child node 115 is not determined to be intersected by ray 100, and so a stack entry corresponding to child node 115 is not pushed to the stack.)

As illustrated in FIG. 10, in this example, ray 100 enters child node 111 nearest to the ray origin 101, child node 112 is next, child node 113 is next, and finally ray 100 enters child node 114 furthest from the ray origin 101. Stack entries may be pushed to the stack in an order such that the stack entry corresponding to the nearest child node 111 is processed first, then the stack entry corresponding to the next child node 112, then the stack entry corresponding to the next child node 113, and finally the stack entry corresponding to the furthest child node 114. That is, stack entries may be pushed to the stack in a “back-to-front” order, such that they may subsequently be popped from the stack and processed in “front-to-back” order (in accordance with a “last-in-first-out” scheme). This “front-to-back” processing order can shorten the time taken to find the closest intersection point 24 of a closest-hit, e.g. primary, ray.

The Applicant has realised, however, that processing child nodes in front-to-back order may not necessarily be optimal in all situations. In particular, the Applicant has realised that while front-to-back order may typically be optimal for “closest-hit” rays, it may not necessarily be optimal for other types of rays, such as “visibility” (e.g. shadow) rays.

Whereas a closest-hit ray attempts to find the closest intersecting geometry to the ray's origin, traversal associated with a visibility ray may be terminated as soon as any intersecting geometry is found. The Applicant has realised that the taken to find any intersection point may be shortened by processing child nodes having a greater probability of containing (any) intersecting geometry before child nodes having a smaller probability of containing (any) intersecting geometry.

Thus, in embodiments, when a closest-hit ray is being traced, child nodes are pushed to the stack in an order that will cause nodes nearer to the ray's origin to be processed before child nodes further away from the ray's origin. When, however, a visibility ray is being traced, child nodes are pushed to the stack in an order that is expected to cause nodes having a greater probability of containing (any) intersecting geometry to be processed before child nodes having a lower probability of containing intersecting geometry.

The Applicant has furthermore realised that the probability of a node containing (any) intersecting geometry can depend on a number of factors, such as the type of scene being rendered, the length of ray being traced, etc. . . . .

For example, in some situations it may be the case that large primitives, e.g. representing a background, are positioned farthest away from a ray origin. For example, in the case of an indoor scene, it can often be the case that walls are present furthest from a ray origin. In this case, it may be optimal to process child nodes for a visibility ray in “back-to-front” order. Thus, in this case, referring to FIG. 10, it may be advantageous to push stack entries to the stack in an order such that the stack entry corresponding to the furthest child node 114 is processed first, then the stack entry corresponding to the next furthest child node 113, then the stack entry corresponding to child node 112, and finally the stack entry corresponding to the nearest child node 111.

For other situations, it may be assumed that the probability of a node containing (any) intersecting geometry is greater for a larger node than for a smaller node. Thus, in this case, referring to FIG. 10, stack entries may be pushed to the stack in an order such that the stack entry corresponding to the largest child node 113 is processed first, then the stack entry corresponding to the next largest child node 114, then the stack entry corresponding to the next largest child node 112, and finally the stack entry corresponding to the smallest child node 111.

Other heuristics representative of the probability of a node containing (any) intersecting geometry are possible. For example, it may be assumed that the probability of a node containing (any) intersecting geometry will be proportional to the number of times the node has previously been visited or intersected by rays during ray traversal. In this case, stack entries may be pushed to the stack in an order such that a stack entry corresponding to a more frequently visited or intersected child node is processed before a stack entry corresponding to a less frequently visited or intersected child node.

The Applicant has accordingly realised that while the optimal strategy for determining child node processing order for closest-hit rays is typically front-to-back, the optimal strategy for determining child node processing order for visibility rays can vary.

To facilitate this, in embodiments of the technology described herein, a flag is stored with a parent node of the acceleration data structure that indicates an ordering strategy to use to determine the order in which to process child nodes of the parent node when tracing a visibility ray. The ordering strategy for a parent node may be selected during acceleration data structure generation, and the flag may be read during acceleration data structure traversal for a visibility ray. This can allow visibility rays to have a different child node processing order to closest-hit rays. Furthermore, different parent nodes can have different child node processing orders. This can facilitate optimisation and acceleration of visibility ray tracing, e.g. by reducing (e.g. minimising) overall traversal time for a visibility ray.

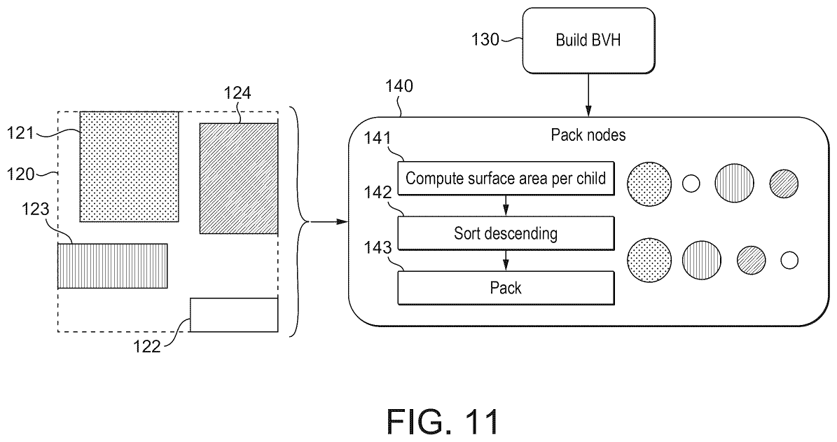

FIG. 11 illustrates acceleration data structure generation according to embodiments of the technology described herein. FIG. 11 shows an exemplary set of child nodes 121-124 of a parent internal node 120 that have been generated as part of an acceleration data structure building process (step 130). For each node, node information is generated and stored for use during ray traversal (step 140). As described above, the node information for a parent node can indicate the parent node volume and associated child node volumes, etc. . . . .

In this example, a “largest-to-smallest” child node processing order is selected for parent node 120. As shown in FIG. 11, when node information for parent node 120 is generated, the surface area of each child node 121-124 is determined (at step 141). The determined surface areas are then sorted into descending order (step 142), and the node information stored for parent node 120 includes information indicating the determined order (step 143). For example, the child nodes may be stored in the determined order. Then, when performing traversal for a visibility ray, the stored order information (e.g. the order in which child nodes are stored) can be used by the RTU 74 to add intersected child nodes to the stack in an order such that the child nodes are processed in “largest-to-smallest” order.

Alternatively, a “back-to-front” processing order may be selected. In this case, information indicating that the child nodes 121-124 should be processed in a back-to-front order is stored with the node information for the parent node 120. Then, when performing traversal for a visibility ray, the stored information triggers the RTU 74 to add intersected child nodes to the stack in an order such that the child nodes are processed in back-to-front order.

Alternatively, a “front-to-back” processing order may be selected. In this case, information indicating that the child nodes 121-124 should be processed in a front-to-back order is stored with the node information for the parent node 120. Then, when performing traversal for a visibility ray, the stored information triggers the RTU 74 to add intersected child nodes to the stack in an order such that the child nodes are processed in front-to-back order.

Other ordering strategies are possible, e.g. as described above.

An ordering strategy that is expected to reduce (e.g. minimise) visibility ray traversal time may be selected. In embodiments, acceleration data structure build time may (also or instead) be considered when selecting an ordering strategy. For example, in the case of a dynamic scene, where it is to be expected that the acceleration data structure will need to be re-built relatively frequently, an ordering strategy that involves determining child node order during acceleration data structure traversal (such as front-to-back or back-to-front) may be selected. On the other hand, in the case of a static scene, where it is to be expected that the acceleration data structure will be re-built less frequently, an ordering strategy that involves determining child node order during acceleration data structure generation (such as largest-to-smallest, or based on another heuristic, e.g. as described above) may be selected.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processing system that is operable to perform ray tracing using a ray tracing acceleration data structure that comprises a plurality of nodes, wherein each node of the plurality of nodes represents a respective volume, and the plurality of nodes includes at least one parent node that is associated with a respective set of child nodes;
wherein the graphics processing system is operable to trace a ray by traversing the ray tracing acceleration data structure and testing the ray against nodes of the ray tracing acceleration data structure to determine whether the ray intersects volumes represented by the nodes, and when it is determined that the ray intersects a volume represented by a parent node, testing the ray against child nodes of the parent node;
the method comprising, for at least one parent node of the ray tracing acceleration data structure:
selecting an ordering strategy for determining an order in which to test rays against child nodes of the parent node; and
storing, in association with the parent node, ordering information indicative of the selected ordering strategy;
the method further comprising, when tracing a ray:
traversing the ray tracing acceleration data structure, and when it is determined that the ray intersects a volume represented by a parent node for which ordering information is stored:
determining, using the stored ordering information, an order in which to test the ray against child nodes of the parent node; and
causing the ray to be tested against child nodes of the parent node in accordance with the determined order.

2. The method of claim 1, wherein selecting an ordering strategy comprises selecting an ordering strategy for determining an order in which to test rays of a particular type; and wherein determining an order comprises determining, using the stored ordering information, an order in which to test a ray of the particular type.

3. The method of claim 2, comprising not using the stored ordering information to determine an order in which to test rays of a different type.

4. The method of claim 2, wherein the particular ray type is visibility ray.

5. The method of claim 1, wherein selecting an ordering strategy for determining an order in which to test rays against child nodes of the parent node comprises:
selecting an ordering strategy that is expected to result in child nodes of the parent node that are more likely to contain any intersecting geometry being tested before child nodes of the parent node that are less likely to contain any intersecting geometry.

6. The method of claim 1, comprising selecting an ordering strategy based on whether the ordering strategy will be used to determine an order in which to test rays against child nodes when generating the ray tracing acceleration data structure or when traversing the ray tracing acceleration data structure.

7. The method of claim 1, comprising determining a child node order based on one or more of: (i) child node position; (ii) child node size; and (iii) child node visit/intersection frequency.

8. The method of claim 1, wherein causing the ray to be tested in accordance with the determined order comprises adding stack entries to a stack for the ray in an order that will cause the stack entries to be processed in accordance with the determined order.

9. A method of generating a ray tracing acceleration data structure for use by a graphics processor; the method comprising:
generating and storing a ray tracing acceleration data structure that comprises a plurality of nodes, wherein each node of the plurality of nodes represents a respective volume, and the plurality of nodes includes at least one parent node that is associated with a respective set of child nodes; and
for at least one parent node of the ray tracing acceleration data structure:
selecting an ordering strategy for determining an order in which to test rays against child nodes of the parent node; and
storing, in association with the parent node, ordering information indicative of the selected ordering strategy.

10. A non-transitory computer readable storage medium storing software code which when executing on a processor performs the method of claim 9.

11. A graphics processing system that is operable to perform ray tracing using a ray tracing acceleration data structure that comprises a plurality of nodes, wherein each node of the plurality of nodes represents a respective volume, and the plurality of nodes includes at least one parent node that is associated with a respective set of child nodes;
the graphics processing system comprising:
a ray tracing circuit operable to trace a ray by traversing a ray tracing acceleration data structure and testing the ray against nodes of the ray tracing acceleration data structure to determine whether the ray intersects volumes represented by the nodes, and when it is determined that the ray intersects a volume represented by a parent node, testing the ray against child nodes of the parent node; and
a processing circuit operable to, for at least one parent node of a ray tracing acceleration data structure:
select an ordering strategy for determining an order in which to test rays against child nodes of the parent node; and
store, in association with the parent node, ordering information indicative of the selected ordering strategy;
wherein the ray tracing circuit is operable to, when tracing a ray:
traverse a ray tracing acceleration data structure, and when it is determined that the ray intersects a volume represented by a parent node for which ordering information has been stored by the processing circuit:
determine, using the stored ordering information, an order in which to test the ray against child nodes of the parent node; and
cause the ray to be tested against child nodes of the parent node in accordance with the determined order.

12. The system of claim 11, wherein the processing circuit is operable to select an ordering strategy for determining an order in which to test rays of a particular type; and wherein the ray tracing circuit is operable to determine, using the stored ordering information, an order in which to test a ray of the particular type.

13. The system of claim 12, wherein the ray tracing circuit is operable to not use the stored ordering information to determine an order in which to test rays of a different type.

14. The system of claim 12, wherein the particular ray type is visibility ray.

15. The system of claim 11, wherein the processing circuit is operable to select an ordering strategy for determining an order in which to test rays against child nodes of a parent node by:
selecting an ordering strategy that is expected to result in child nodes of the parent node that are more likely to contain any intersecting geometry being tested before child nodes of the parent node that are less likely to contain any intersecting geometry.

16. The system of claim 11, wherein the processing circuit is operable to select an ordering strategy based on whether the ordering strategy will be used to determine an order in which to test rays against child nodes when generating the ray tracing acceleration data structure or when traversing the ray tracing acceleration data structure.

17. The system of claim 11, wherein the system is operable to determine a child node order based on one or more of: (i) child node position; (ii) child node size; and (iii) child node visit/intersection frequency.

18. The system of claim 11, wherein the ray tracing circuit is operable to cause a ray to be tested in accordance with a determined order by adding stack entries to a stack for the ray in an order that will cause the stack entries to be processed in accordance with the determined order.

19. A graphics processor that is operable to perform ray tracing using a ray tracing acceleration data structure that comprises a plurality of nodes, wherein each node of the plurality of nodes represents a respective volume, and the plurality of nodes includes at least one parent node in association with which ordering information is stored that is indicative of a selected ordering strategy for determining an order in which to test rays against child nodes of the parent node;
the graphics processor comprising:
a ray tracing circuit operable to trace a ray by traversing a ray tracing acceleration data structure and testing the ray against nodes of the ray tracing acceleration data structure to determine whether the ray intersects volumes represented by the nodes; and
an ordering circuit operable to, when it is determined by the ray tracing circuit that a ray intersects a volume represented by a parent node for which ordering information is stored:
determine, using the stored ordering information, an order in which to test the ray against child nodes of the parent node; and
cause the ray to be tested against child nodes of the parent node in accordance with the determined order.
